(19) United States
(12) Patent Application Publication
(10) Pub. No.: US 2022/0052343 A1
(43) Pub. Date: Feb. 17, 2022

(54) ALL-SOLID-STATE BATTERY INCLUDING LITHIUM PRECIPITATE

(71) Applicants: HYUNDAI MOTOR COMPANY, Seoul (KR); KIA CORPORATION, Seoul (KR)

(72) Inventors: Jae Min Lim, Suwon-si (KR); Hong Suk Choi, Hwaseong-si (KR); Sang Wan Kim, Daejeon (KR); Young Jin Nam, Suwon-si (KR)

(21) Appl. No.: 17/327,936

(22) Filed: May 24, 2021

(30) Foreign Application Priority Data
Aug. 12, 2020 (KR) 10-2020-0100942

(51) Int. Cl. H01M 4/587; H01M 10/0525; H01M 4/40

(52) U.S. Cl. CPC H01M 4/587; H01M 2004/021; H01M 4/405; H01M 10/0525

(57) ABSTRACT

An all-solid-state battery includes: a cathode-current-collector layer, a first layer disposed on the cathode-current-collector layer, and including at least one selected from the group consisting of a particulate carbon material, a fibrous carbon material, and a combination thereof; a second layer arranged between the first layer and the cathode-current-collector layer, and including a carbon material having a layered structure; an electrolyte layer disposed on the first layer; and a complex anode layer disposed on the electrolyte layer.

### CROSS REFERENCE TO RELATED APPLICATION

The present application claims priority based on Korean Patent Application No. 10-2020-0100942, filed on Aug. 12, 2020 in the Korean Intellectual Property Office, the entire content of which is incorporated herein for all purposes by this reference.

### TECHNICAL FIELD

The present disclosure relates to an all-solid-state battery having an anodeless structure including a lithium precipitate.

### BACKGROUND

An all-solid-state battery includes a three-layer laminate including an anode complex layer bonded to an anode current collector, a cathode complex layer bonded to a cathode current collector, and a solid electrolyte disposed between the anode complex layer and the cathode complex layer.

In general, the cathode complex layer of the all-solid-state battery is formed by mixing an active material and a solid electrolyte to secure ionic conductivity. Since the solid electrolyte has a specific gravity that is greater than that of a liquid electrolyte, the conventional all-solid-state battery as described above has energy density lower than that of a lithium ion battery.

In order to increase the energy density of the all-solid-state battery, research has been conducted with the goal of using lithium metal as a cathode. However, there are problems such as interfacial bonding, growth of dendrites, costs, and difficulty in realizing a large area.

Recently, research on a storage-anodeless type in which the cathode of an all-solid-state battery is removed and lithium is directly precipitated on a cathode current collector has also been studied. However, the above battery has a problem in that the extent of an irreversible reaction gradually increases due to non-uniform precipitation of lithium, and thus durability is very poor.

The information included in this Background section is only for enhancement of understanding of the general background of the present disclosure and may not be taken as an acknowledgement or any form of suggestion that this information forms the prior art already known to a person skilled in the art.

### SUMMARY OF THE DISCLOSURE

An objective of the present disclosure is to provide an all-solid-state battery having a new structure characterized by improved durability compared to a conventional anodeless-type all-solid-state battery.

Another objective of the present disclosure is to provide an all-solid-state battery having good durability and high energy density.

The objectives of the present disclosure are not limited to the objectives mentioned above. The objectives of the present disclosure will become more apparent from the following description, and will be realized by the means described in the claims and combinations thereof.

An all-solid-state battery according to an embodiment of the present disclosure includes: a cathode-current-collector layer; a first layer disposed on the cathode-current-collector layer, and including at least one selected from the group consisting of a particulate carbon material, a fibrous carbon material, and a combination thereof; a second layer arranged between the first layer and the cathode-current-collector layer, and including a carbon material having a layered structure; an electrolyte layer disposed on the first layer; and a complex anode layer disposed on the electrolyte layer.

The first layer may be porous.

The particulate carbon material may include at least one selected from the group consisting of carbon black, graphitizing carbon, non-graphitizing carbon, and a combination thereof. The particulate carbon material may have a particle size (D50) of 0.01 to 5 μm.

The fibrous carbon material may include at least one selected from the group consisting of carbon nanofibers, carbon nanotubes, vapor-grown carbon fibers, and a combination thereof.

The fibrous carbon material may have a diameter of 0.01 to 5 μm.

The first layer may have a thickness of 3 to 30 μm.

The first layer may further include a powdery metal capable of forming an alloy with lithium.

The metal may include at least one selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and a combination thereof.

The metal may have a particle size (D50) of 0.01 to 5 μm.

The carbon material having the layered structure may include at least one selected from the group consisting of graphite, graphene having a laminated structure, and a combination thereof.

In the all-solid-state battery, during charging, a lithium precipitate may be inserted between layers of the carbon material having the layered structure.

In the all-solid-state battery, the second layer may be thinner than the first layer.

The second layer may have a thickness of 0.5 to 5 μm.

The all-solid-state battery may further include a lithium metal layer positioned between the second layer and the cathode-current-collector layer. The lithium metal layer may include a lithium precipitate.

According to the present disclosure, since lithium may be uniformly precipitated on a cathode-current-collector layer, it is possible to obtain an all-solid-state battery having improved durability and energy density.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 is a cross-sectional view showing an all-solid-state battery according to an embodiment of the present disclosure;

FIG. 2 is a cross-sectional view showing a charging state of the all-solid-state battery according to an embodiment of the present disclosure;

FIG. 3 shows the result obtained by analyzing the cross section of the all-solid-state battery manufactured in an Example using a scanning electron microscope;

FIG. 4A shows the result obtained by analyzing the cross section of an all-solid-state battery in a charging state in the Example using a scanning electron microscope;

FIG. 4B shows the result obtained by analyzing the cross section of an all-solid-state battery in a charging state in a Comparative Example using a scanning electron microscope;

FIG. 5A shows the result obtained by measuring the charging and discharging capacities of the solid-state batteries of the Example and the Comparative Example; and

FIG. 5B shows the result obtained by measuring a capacity retention rate according to the number of charges and discharges of the solid-state batteries of the Example and the Comparative Example.

### DETAILED DESCRIPTION OF THE EMBODIMENTS

The above and other objectives, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

FIG. 1 shows an all-solid-state battery according to an embodiment of the present disclosure. An all-solid-state battery 1 includes a cathode-current-collector layer 10, a lithium-absorbing layer 20 which is positioned on the cathode-current-collector layer 10 and which provides a space for lithium to precipitate, an electrolyte layer 30 positioned on the lithium-absorbing layer 20, and a complex anode layer 40 positioned on the electrolyte layer 30.

The cathode-current-collector layer 10 may be a kind of sheet-shaped substrate. In addition, the cathode-current-collector layer 10 may be a metal thin film including at least one metal selected from the group consisting of copper (Cu), nickel (Ni), and a combination thereof. Specifically, the cathode-current-collector layer 10 may be a high-density metal thin film having a porosity of less than about 1%.

The cathode-current-collector layer 10 may have a thickness of 1 to 20 μm, or more specifically 5 to 15 μm.

The lithium-absorbing layer 20 includes a first layer 21 and a second layer 22 positioned between the first layer 21 and the cathode-current-collector layer 10.

The first layer 21 may be a porous layer having amorphous pores therein. When the all-solid-state battery 1 is charged, lithium ions that are generated from the complex anode layer and then move through the electrolyte layer 30 may be deposited in the pores of the first layer 21.

When the all-solid-state battery 1 is charged, lithium ions that are generated from the complex anode layer 40 and then move through the electrolyte layer 30 may precipitate in the pores of the first layer 21.

The first layer 21 may include at least one selected from the group consisting of a particulate carbon material, a fibrous carbon material, and a combination thereof.

The particulate carbon material may include at least one selected from the group consisting of carbon black, graphitizing carbon, non-graphitizing carbon, and a combination thereof.

The carbon black is not particularly limited, but examples thereof may include at least one selected from the group consisting of Super P, Super C, acetylene black, Ketjen black, and a combination thereof.

The graphitizing carbon and the non-graphitizing carbon are non-graphite-based carbon, and may be a carbon material in which crystallizers are tangled together and arranged in a disorderly manner.

The particle size (D50), e.g., diameter, of the particulate carbon material may be 0.01 to 5 μm. It is possible to form adequate pores in the first layer 21 only when the particle size (D50) of the particulate carbon material falls within the above numerical range. Here, for particle size distributions the median is called the D50 (or x50 when following certain ISO guidelines). The D50 is the size in microns that splits the distribution with half above and half below this diameter.

The first layer 21 including the fibrous carbon material may have a network structure formed by connecting the fibrous carbon materials in three dimensions.

The fibrous carbon material may include at least one selected from the group consisting of carbon nanofibers, carbon nanotubes, vapor-grown carbon fibers, and a combination thereof.

The diameter of the fibrous carbon material may be 0.01 to 5 μm. It is possible to form adequate pores in the first layer 21 only when the diameter of the fibrous carbon material falls within the above numerical range.

The first layer 21 may have a thickness of 3 to 30 μm. Further, the porosity of the first layer 21 may be 10 to 80%. It is possible to improve the energy density of the all-solid-state battery only when the thickness and porosity of the first layer 21 fall within the above numerical range.

The first layer 21 may further include a powdery metal capable of forming an alloy with lithium.

The metal may act as a kind of seed for lithium ions in the first layer 21. Specifically, as the all-solid-state battery 1 is charged, the lithium ions are mainly grown into lithium around the metal.

The metal may include at least one selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and a combination thereof.

The particle size (D50) of the metal is not particularly limited, but may be, for example, 0.01 to 5 μm or 0.1 to 1 μm.

The second layer 22 may include a carbon material having a layered structure. The second layer 22 may be provided in the form of a thin film between the first layer 21 and the cathode current collector 10. Since the first layer 21 has poor lithium ionic conductivity and has amorphous pores therein, lithium ions move non-uniformly depending on the location within the first layer 21. Since the second layer 22 has a predetermined structure including a carbon material having a layered structure, the second layer may act as a kind of buffer layer for lithium ions passing through the first layer 21. Specifically, the lithium ions are uniformly stored between the layers of the carbon material having the layered structure in the second layer 22, and then start to precipitate on the lithium current collector layer 10. As a result, according to the present disclosure, the movement and precipitation rates of lithium ions depending on the location thereof may be balanced due to the second layer 22, thereby inducing uniform lithium precipitation.

The carbon material having the layered structure may include at least one selected from the group consisting of graphite, graphene having a laminated structure, and a combination thereof.

The graphite means crystalline graphite and may include natural graphite and artificial graphite.

The graphene having the laminated structure means that a plurality of graphenes is laminated to form a layered structure.

The thickness of the second layer 22 may be 0.5 to 5 μm. It is possible to balance the movement and precipitation rates of lithium ions so that lithium is uniformly precipitated on the cathode-current-collector layer 10 only when the thickness of the second layer 22 falls within the above numerical range.

FIG. 2 shows a charging state of the all-solid-state battery 1 according to an embodiment of the present disclosure. Referring to this, the all-solid-state battery 1 may further include a lithium metal layer A positioned between the second layer 22 and the cathode-current-collector layer 10. The lithium metal layer A includes a lithium precipitate, and the lithium precipitate may be a precipitate of lithium ions passing through the first layer 21 and the second layer 22.

The electrolyte layer 30 is positioned between the porous layer 20 and the complex anode layer 40 to thus allow lithium ions to move between the two components.

The electrolyte layer 30 may include an oxide-based solid electrolyte or a sulfide-based solid electrolyte. However, it may be preferable to use a sulfide-based solid electrolyte having high lithium ionic conductivity. The sulfide-based solid electrolyte is not particularly limited, but may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers and Z is one of Ge, Zn, and Ga) , Li₂S—GeS₂, Li₂S—SiS₂-Li₃PO₄, Li₂S—SiS₂—LiₓMO_{y} (where x and y are positive numbers and M is one of P, Si, Ge, B, Al, Ga, and In), or Li₁₀GeP₂S₁₂.

The complex anode layer 40 may include an anode active material layer 41 provided on the electrolyte layer 30 and an anode-current-collector layer 42 provided on the anode active material layer 41.

The anode active material layer 41 may include an anode active material, a solid electrolyte, a conductive material, and a binder.

The anode active material may be an oxide active material or a sulfide active material.

The oxide active material may be a rock-salt-layer-type active material such as LiCoO₂, LiMnO₂, LiNiO₂, LiVO₂, and Li₁₊ₓNi_{1/3}CO_{1/3}Mn_{1/3}O₂, a spinel-type active material such as LiMn₂O₄ and Li(Ni_{0.5}Mn_{1.5})O₄, a reverse-spinel-type active material such as LiNiVO₄ and LiCoVO₄, an olivine-type active material such as LiFePO₄, LiMnPO₄, LiCoPO₄, and LiNiPO₄, an active material containing silicon such as Li₂FeSiO₄ and Li₂MnSiO₄, a rock-salt-layer-type active material, such as LiNi_{0.8}CO_{(0.2-x)}AlₓO₂ (0<x<0.2), in which a part of a transition metal is replaced with a dissimilar metal, a spinel-type active material in which a part of a transition metal is replaced with a dissimilar metal, such as Li₁₊ₓMn_{2-x-y}M_{y}O₄ (where M is at least one of Al, Mg, Co, Fe, Ni, and Zn and 0<x+y<2), or lithium titanate such as Li₄Ti₅O₁₂.

The sulfide active material may be copper chevrel, iron sulfide, cobalt sulfide, or nickel sulfide.

The solid electrolyte may be an oxide solid electrolyte or a sulfide solid electrolyte. However, it may use a sulfide-based solid electrolyte having high lithium ionic conductivity. The sulfide-based solid electrolyte is not particularly limited, but may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers and Z is one of Ge, Zn, and Ga), Li₂S—GeS₂, Li₂S—SiS₂—Li₃PO₄, Li₂S—SiS₂—LiₓMO_{y} (where x and y are positive numbers and M is one of P, Si, Ge, B, Al, Ga, and In), or Li₁₀GeP₂S₁₂. The solid electrolyte may be the same as or different from that included in the electrolyte layer 30.

The conductive material may be carbon black, conductive graphite, ethylene black, or graphene.

The binder may be BR (butadiene rubber), NBR (nitrile butadiene rubber), HNBR (hydrogenated nitrile butadiene rubber), PVDF (polyvinylidene difluoride), PTFE (polytetrafluoroethylene), or CMC (carboxymethylcellulose). The binder may be the same as or different from the binder included in the porous layer 20.

The anode-current-collector layer 42 may be made of aluminum foil.

Other forms of the present disclosure will be described in more detail with reference to Examples below. The following Examples are only examples to aid understanding of the present disclosure, and the scope of the present disclosure is not limited thereto.

### EXAMPLE

A first layer including Super C, as a particulate carbon material, and silver (Ag), as a metal, was formed. Silver (Ag) having a particle size (D50) of 0.15 μm was used. The thickness of the first layer was adjusted to 8 μm.

A thin film having a thickness of 1 μm was applied on the first layer using a wire bar to form a second layer. Artificial graphite was used as the carbon material having the layered structure constituting the second layer.

A lithium-absorbing layer including the first layer and the second layer was combined with a cathode-current-collector layer in the form shown in FIG. 1, and an electrolyte layer and a complex anode layer were laminated on the lithium-absorbing layer, thus manufacturing an all-solid-state battery. As the cathode-current-collector layer, the electrolyte layer, and the complex anode layer, those commonly used in the technical field to which the present disclosure belongs were used.

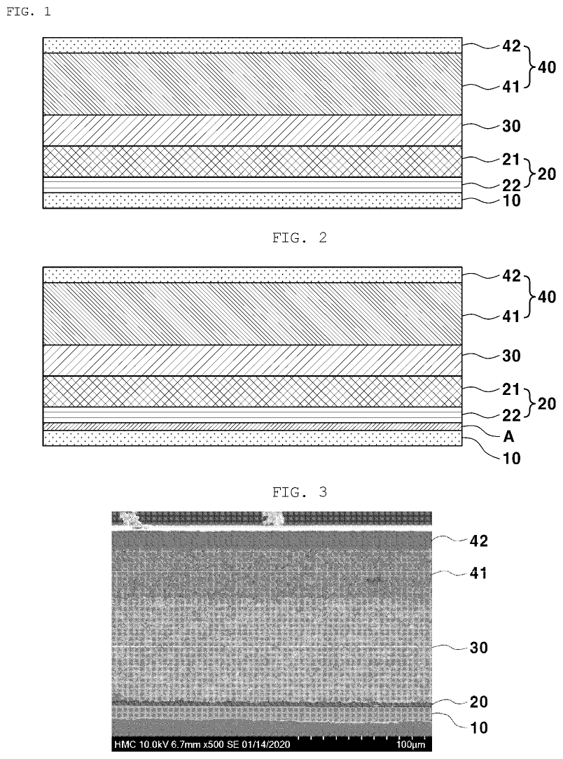

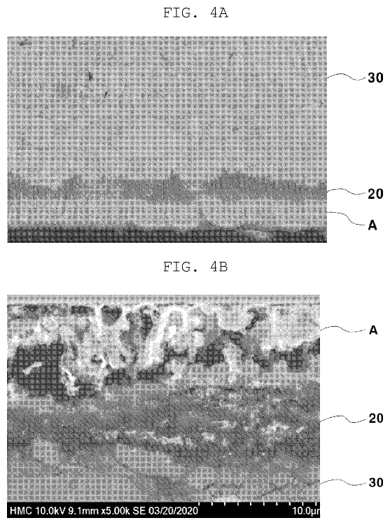

FIG. 3 shows the result obtained by analyzing the cross section of the all-solid-state battery according to an Example using a scanning electron microscope.

### Comparative Example

An all-solid-state battery was manufactured in the same manner as in the above Example, except that a second layer was not formed. That is, in the all-solid-state battery of the Comparative Example, a cathode current collector, a first layer, an electrolyte layer, an anode active material layer, and an anode-current-collector layer are sequentially laminated.

### Experimental Example 1—Scanning Electron Microscope Analysis of an All-Solid-State Battery in Charging State

After the solid-state batteries according to the Example and the Comparative Example were charged, each all-solid-state battery was analyzed with a scanning electron microscope.

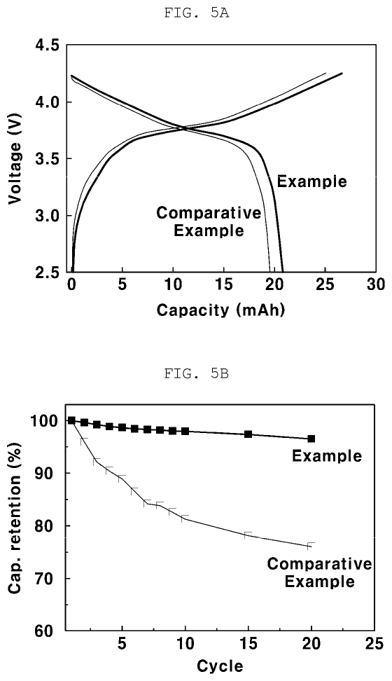

FIG. 4A shows the result of the Example, and FIG. 4B shows the result of the Comparative Example.

Referring to FIG. 4A, it can be seen that in the all-solid-state battery according to the Example, the precipitated lithium metal layer A was uniform and dense even though the thickness of the lithium-absorbing layer 20 was non-uniform.

Referring to FIG. 4B, it can be seen that in the all-solid-state battery according to the Comparative Example, the lithium metal layer A was not uniformly formed on the first layer, and many holes were formed. That is, in the all-solid-state battery of the Comparative Example, a lot of dead lithium is generated.

### Experimental Example 2—Evaluation of Cell Characteristics

The charging and discharging capacities of the solid-state batteries according to the Example and the Comparative Example were measured. The results are shown in FIG. 5A.

Further, a capacity retention rate according to the number of charges and discharges of the solid-state batteries according to the Example and the Comparative Example was measured. The results are shown in FIG. 5B.

Referring to FIGS. 5A and 5B, it can be seen that the all-solid-state battery of the Example has a larger capacity and also has a remarkably improved capacity retention rate, that is, durability.

The present disclosure has been described in detail herein above with respect to test examples and embodiments.

However, the scope of the present disclosure is not limited to the aforementioned test examples and examples, and various modifications and improved modes of the present disclosure using the basic concept of the present disclosure defined in the accompanying claims are also incorporated in the scope of the present disclosure.

What is claimed is:

1. An all-solid-state battery comprising:
a cathode-current-collector layer;
a first layer disposed on the cathode-current-collector layer, and including at least one selected from the group consisting of a particulate carbon material, a fibrous carbon material, and a combination thereof;
a second layer arranged between the first layer and the cathode-current-collector layer, and including a carbon material having a layered structure;
an electrolyte layer disposed on the first layer; and
a complex anode layer disposed on the electrolyte layer.

2. The all-solid-state battery of claim 1, wherein the first layer is porous.

3. The all-solid-state battery of claim 1, wherein the particulate carbon material includes at least one selected from the group consisting of carbon black, graphitizing carbon, non-graphitizing carbon, and a combination thereof.

4. The all-solid-state battery of claim 1, wherein the particulate carbon material has a particle diameter size (D50) of 0.01 to 5 μm.

5. The all-solid-state battery of claim 1, wherein the fibrous carbon material includes at least one selected from the group consisting of carbon nanofibers, carbon nanotubes, vapor-grown carbon fibers, and a combination thereof.

6. The all-solid-state battery of claim 1, wherein the fibrous carbon material has a diameter of 0.01 to 5 μm.

7. The all-solid-state battery of claim 1, wherein the first layer has a thickness of 3 to 30 μm.

8. The all-solid-state battery of claim 1, wherein the first layer further includes a powdery metal capable of forming an alloy with lithium.

9. The all-solid-state battery of claim 8, wherein the metal includes at least one selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and a combination thereof.

10. The all-solid-state battery of claim 8, wherein the metal has a particle diameter size (D50) of 0.01 to 5 μm.

11. The all-solid-state battery of claim 1, wherein the carbon material having the layered structure includes at least one selected from the group consisting of graphite, graphene having a laminated structure, and a combination thereof.

12. The all-solid-state battery of claim 1, wherein, during charging, a lithium precipitate is configured to be arranged between layers of the carbon material having the layered structure.

13. The all-solid-state battery of claim 1, wherein the second layer has a thickness smaller than that of the first layer.

14. The all-solid-state battery of claim 1, wherein the second layer has a thickness of 0.5 to 5 μm.

15. The all-solid-state battery of claim 1, further comprising a lithium metal layer arranged between the second layer and the cathode-current-collector layer,
wherein the lithium metal layer includes a lithium precipitate.
